(19) United States
(12) Patent Application Publication
(10) Pub. No.: US 2009/0161094 A1
(43) Pub. Date: Jun. 25, 2009

(54) WAFER BEVEL INSPECTION MECHANISM

(76) Inventor: Cory M. Watkins, Eden Prairie, MN (US)

Correspondence Address: DICKE BILLIG & CZAJA, PLLC;ATTN: CHRISTOPHER MCLAUGHLIN, 100 SOUTH FIFTH STREET, SUITE 2250, MINNEAPOLIS, MN, 55402, US

(21) Appl. No.: 12/296,026

(22) PCT Filed: Apr. 3, 2007
(86) PCT No.: PCT/US07/08122

§ 371 Date: Oct. 3, 2008

Related U.S. Application Data
(60) Provisional application No. 60/788,642, filed on Apr. 3, 2006.

(51) Int. Cl. G01N 21/88; H04N 7/18; G06K 9/00

(52) U.S. Cl. 356/237.2; 348/126; 382/149; 348/E07.085

(57) ABSTRACT

An imaging sensor for capturing images of the beveled surface of a wafer edge is herein disclosed. The imaging sensor is aligned with the edge of a wafer to maximize the area of the bevel that is encompassed by the depth of view of the imaging sensor. One or more sensors may be used to capture images of the wafer edge.

### CROSS-REFERENCE TO RELATED APPLICATION

This application claims priority under 35 U.S.C. 371 to PCT Patent Application No. PCT/U.S. Ser. No. 07/08122, filed Apr. 3, 2007, entitled “Wafer Bevel Inspection Mechanism”, which claims priority to U.S. Provisional Patent Application Serial No. 60/788,642, filed Apr. 3, 2006, entitled “Wafer Bevel Inspection Mechanism”, the entire teachings of which are incorporated herein by reference.

### TECHNICAL FIELD

The present disclosure relates generally to a mechanism and method of using a line scan camera to capture defect data from the bevel of a semiconductor wafer edge.

### BACKGROUND

Because many of the defects that can render a die on a semiconductor wafer unusable can have their origins at the edge of the wafer, it is important to inspect the edges of wafers to identify defects and determine their source so that usable die yields may be improved.

It is known to inspect the edge of a semiconductor wafer using imaging devices (cameras) that are arranged above and below a wafer that are positioned such that the optical paths of the imaging devices are substantially normal to the upper and lower surfaces of the wafer. Other imaging devices are positioned such that their optical paths are substantially within the plane defined by the wafer itself. In this way, substantially all of a wafer edge region may be imaged. FIG. 2 schematically illustrates an edge region of a wafer W as having an edge top area (ET), a top edge bevel area (TE), an edge normal area (EN), a bottom edge bevel (BE), and an edge bottom area (EB). Note that the wafer W illustrated has a beveled edge B. The terms “bevel” and “edge” may be used interchangeably herein to refer to the various regions of an edge of a wafer W, however, the terms “edge top”, “top edge bevel”, “edge normal”, “bottom edge bevel”, and “edge bottom” will be used to describe specific areas or regions of the edge of a wafer.

Where portions of the edge of the semiconductor wafer fall outside of the depth-of-field of imaging devices as shown in FIGS. 1a and 1b, it may be difficult to rapidly and reliably inspect the edge of a wafer as those portions outside of the depth-of-field D will be out of focus and spurious defects may be found or actual defects may be missed.

Accordingly, there is a need for an optical wafer inspection system that can rapidly and reliably obtain inspection data concerning the edge of a semiconductor wafer and particularly concerning the bevel surface of the wafer edge at high resolutions.

### SUMMARY

An imaging sensor for capturing images of the beveled surface of a wafer edge is herein disclosed. The imaging sensor is substantially aligned with a beveled edge of a wafer to maximize the area of the bevel that is encompassed by the depth of view of the imaging sensor.

### BRIEF DESCRIPTION OF THE DRAWINGS

FIGS. 1a and 1b are schematic illustrations showing how a field of view of an imaging sensor may fail to encompass the entire surface of a wafer bevel.

FIG. 2 is a schematic cross section of a wafer bevel region.

FIG. 3 is a schematic elevational illustration of an embodiment of a wafer bevel inspection system having two imaging sensors.

FIG. 4 is a schematic top view of an embodiment of an inspection system having wafer bevel imaging sensors and an edge normal imaging sensor.

FIG. 5 is a schematic top view of an embodiment wherein an edge bevel imaging sensor is arranged at an oblique angle with respect to a wafer edge.

FIG. 6 is a schematic top view of an embodiment wherein an edge bevel imaging sensor is arranged at an oblique angle with respect to the wafer edge further including an edge normal imaging sensor.

FIG. 7 is a schematic top view of an embodiment wherein the imaging sensors have two distinct positions with respect to a wafer.

FIG. 8 is a schematic elevation of an embodiment wherein imaging sensors are rotated to capture images of substantially the entire wafer bevel region.

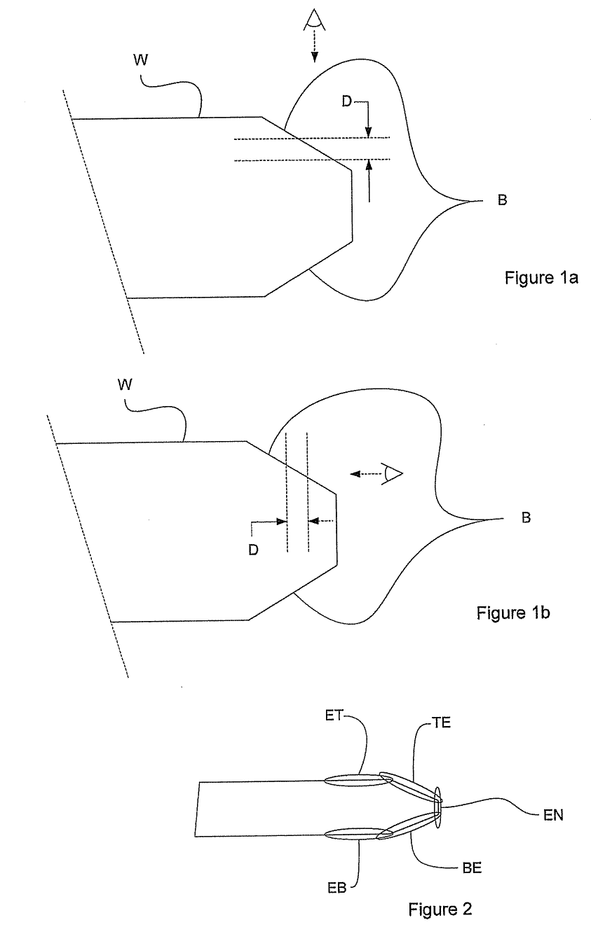

### DETAILED DESCRIPTION

In the following detailed description, reference is made to the accompanying drawings that form a part hereof, and in which is shown, by way of illustration, specific embodiments in which the disclosure may be practiced. In the drawings, like numerals describe substantially similar components throughout the several views. These embodiments are described in sufficient detail to enable those skilled in the art to practice the disclosure. Other embodiments may be utilized and structural, logical, and electrical changes may be made without departing from the scope of the present disclosure. The following detailed description is, therefore, not to be taken in a limiting sense, and the scope of the present disclosure is defined only by the appended claims and equivalents thereof.

As seen in FIG. 3, a wafer W is supported upon a wafer support 24 rotational stage 20 that rotates the wafer W, and particularly the bevel B of the wafer W, with respect to one or more inspection sensors 10. The rotational stage 20 may itself by adapted for movement along a vertical axis (preferably the axis of rotation 21 of the rotational stage 20) by mounting the rotational stage 20 or otherwise coupling the wafer support 24 to a vertical adjustment mechanism 22 shown schematically in FIG. 3. Note that though FIG. 3 illustrates two inspection sensors 10, it is to be understood that one, three or any suitable number of inspection sensors 10 may be used. As can be seen in FIG. 3, inspection sensors 10 (imaging devices) are mounted such that an optical axis 12 of the inspection sensor 10 is as close to normal to the edge bevel B of a semiconductor wafer W as possible. Where the bevels B are flat or nearly so, determining the angle of the wafer bevel and positioning the inspection sensor 10 so as to be normal thereto is relatively simple. Wafers W may have edges with bevels B of many different shapes, including, but not limited to chamfered (as illustrated), round or bull nose elliptical or even square. Note that because of variations in the fabrication of a wafer W, the wafer edge may vary in shape or it may vary by design. In one embodiment where the bevel B of a wafer W is curvilinear, the optical axis 12 of the inspection sensor 10 will be placed approximately normal to a line that approximates a major axis of the curvilinear shape of the wafer bevel B. In this case or in the case where a wafer bevel B is essentially rectilinear (chamfered), the inspection sensor 10 is positioned so as to maximize the surface area of the wafer bevel B or other selected edge region that falls within the depth of view or depth of field D of the inspection sensor 10.

Inspection sensor 10 includes, at a minimum, an optical sensor 11 for capturing an optical image of a wafer W and an optical system 14 that may include one or more objectives 15 or other optical elements (not shown). An example of a suitable inspection sensor 10 is shown in U.S. patent application Ser. No. 10/890,692,filed on Jul. 14, 2004 for an Edge Normal Process, assigned in common herewith and hereby incorporated by reference.

The optical sensor 11 may be of an area scan type, such as a CCD or CMOS type optical sensor, or may be of a line scan type such as a line scan sensor or a TDI sensor. Note that in some embodiments, the inspection sensor 10 may include an area scan optical sensor 11 that is “masked” either physically or electronically to operate as a line scan type optical sensor. Masking an area scan optical sensor 15 involves limiting the output of the sensor to one or to only a few rows of the sensor such that the output of the area scan optical sensor is data from what is essentially a line of pixels.

The optical system 14 of the inspection sensor 10 is adapted to provide a usable image to the optical sensor 11. Typically, the optical system will include standard microscope-type objectives 14 and in some embodiments will include multiple such objectives 14 at various magnification levels such as, by way of example only, 1×, 2×, 5×, and 10× objectives. In some embodiments, the optical system 14 may include objectives 15 adapted specifically for use with line scan or TDI optical sensors 11. In one embodiment, the optical system 14 includes one or more cylindrical optical elements 15 intended for use with line scan or TDI optical sensors 11. Where multiple objectives or optical elements 15 are provided, these optical elements may be changed or switched manually, however it is preferred to mount such optical elements on a turret or slide (not shown) to allow for the automated modification of the magnification of the inspection sensor 10.

Focus of the optical system 14 may be accomplished by providing the objectives 15 with an integral focusing mechanism of a type well understood in the art and/or may be provided by mounting the entire inspection sensor 10 on a linear actuator 16 to move the inspection sensor 10 generally toward and away from the bevel B of the wafer W to maintain as much of a selected region or area of the bevel B within the depth of field of the inspection sensor 10. Optionally, the inspection sensor 10 may also be coupled to a rotational actuator (show schematically by arrow 19). The actuator 19 may be used to align the optical system 14 of the inspection sensor 10 with a selected region of the bevel B.

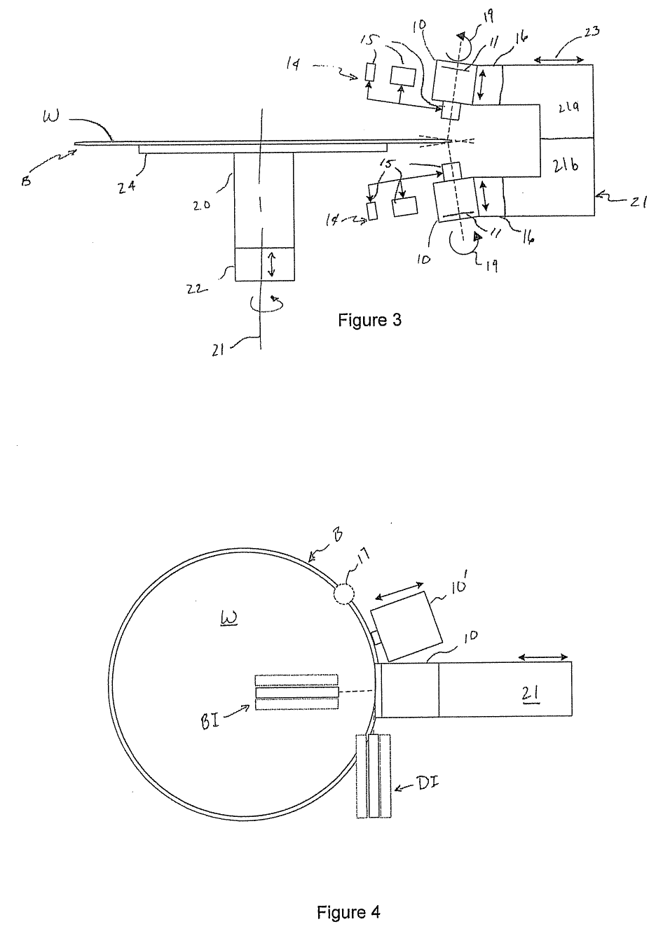

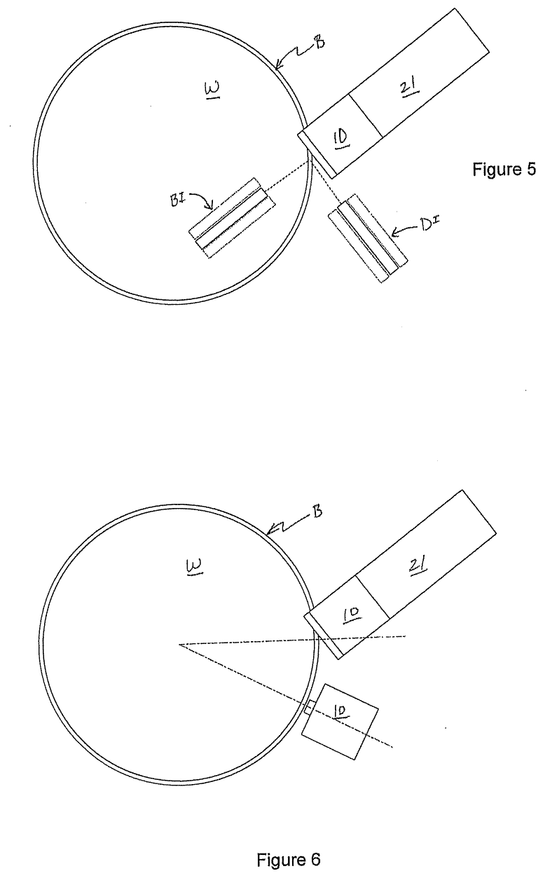

FIG. 3 schematically illustrates two inspection sensors 10 coupled to a moveable mount 21. The moveable mount 21 is coupled to a chassis (not shown) of an inspection system and provides support for the inspection sensors 10. The mount 21 may be provided with linear or rotary actuators (shown schematically by arrow 23) adapted to move the inspection sensors 10 with respect to the wafer support 24, which, while it does rotate, is typically in a fixed position. In this manner, the moveable mount 21 can maintain the inspection sensors 10 in an appropriate position vis-a-vis the bevel B of the wafer at substantially all times. This is useful when a wafer W has been mounted on the wafer support 24 off-center. Further, the inspection sensor 10 may be dynamically positioned by linear actuator 16 to maintain the inspection system 10 in the desired position where the wafer bevel B is vertically displaced. FIG. 4 illustrates one such embodiment that includes a bevel position sensor 17 that obtains position information concerning the position of the bevel B in a vertical and/or radial direction on a real time basis. In some embodiments the sensor 17 is omitted and data concerning the position of the bevel B in a vertical and/or radial direction is obtained from previous inspections, e.g. a 2D/3D inspection of the upper surface of the wafer W. Alternatively, the wafer support 24 may be a vacuum chuck that draws the wafer W into contact with its substantially planar surface, thereby flattening the wafer W to such degree that inspection of the bevel B may take place without regard for adjusting the position of the inspection sensor 10 in a generally vertical direction, i.e. linear actuator 16 may be omitted.

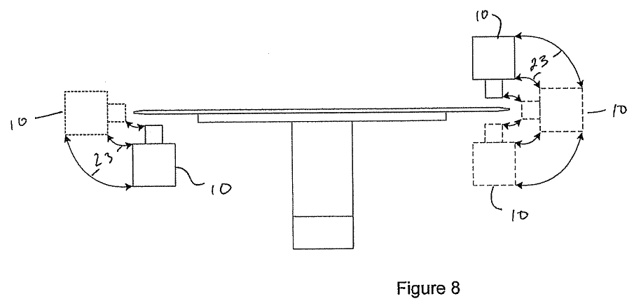

Moveable mount 21 is shown in FIG. 3 as a single unit. However, in other embodiments, the mount 21 may comprise respective mounts 21a and 21b that separately support the respective inspection sensors 10. In some embodiments, mount 21 supports multiple inspection sensors 10 positioned to inspect specific regions of the bevel B in a modular fashion, e.g. sensors 10, each dedicated to the inspection of a specific region of the bevel B are mounted on respective, single moveable mounts 21. Other variations of the mount 21 involve the inclusion of rotary actuators adapted to move one or more inspection sensors 10 through an arc (simple or complex) as shown in FIG. 8. In FIG. 8, the inspection sensor 10 illustrated on the right is moved or rotated by a mount 21 (represented schematically by arc 23) so as to address the optical system 14 and optical sensor 11 thereof to substantially all the discrete regions of the bevel B. Inspection of a bevel B using a sensor mounted on a mount 21 of this arrangement would involve rotating the wafer W past the inspection sensor 10 while operating the inspection sensor 10 to capture images of the wafer W. Given a sufficiently large field of view of the optical system 14, the mount 21 can move the inspection sensor 10 in a continuous manner from its uppermost position to its lower position. Overlapping images may be used for alignment or stitching purposes or may be cropped. Alternatively, the inspection sensor 10 may be moved piecewise between a set of positions, each position being chosen so that the inspection sensor addresses a selected region of the wafer bevel B. The wafer W is rotated through 360° for each position of the inspection sensor 10. Again, overlapping images may be used for alignment or stitching purposes or may be cropped.

Recognizing the complexity of moving a single inspection sensor 10 along a path that describes substantially 180° of the wafer edge, it may be simpler to utilize two inspection sensors 10 to fully inspect the wafer edge. As seen in FIG. 8, the lower left inspection sensor 10 is rotated or moved around the wafer edge by a mount represented by arc 27. Note that the lower left inspection sensor 10 moves between a position in which it is substantially addressed to the edge bottom EB region of the wafer edge to a position in which it is substantially addressed to the edge normal EN region of the wafer edge. A second inspection sensor (not shown) may be employed to address the upper portion of the wafer edge. Additional stationary inspection sensors may also be employed as illustrated in FIGS. 3-6.

FIG. 4 illustrates an inspection sensor 10 coupled to a moveable mount 21. The moveable mount 21 may include the linear and/or rotary stages described above or may be a relatively fixed apparatus. Supplemental inspection sensors 10′ may be included to inspection selected regions of the wafer edge. For example, inspection sensor 10′ may be adapted to capture images of the edge normal EN region of the wafer bevel while inspection sensors 10 are directed primarily toward the upper and lower bevel regions TE and BE of the wafer edge. FIG. 4 also schematically illustrates both brightfield and darkfield illumination sources BI, DI. By definition, brightfield illumination is reflected from the surface under observation and, in this instance, through the optical system 14 and onto optical sensor 11. Darkfield illumination is incident on the surface of the wafer W under observation by the inspection sensor 10 and illuminations features on the wafer W only when those features reflect light into optical system 14 and onto optical sensor 11. Illumination sources BI and DI may be broad band, white light sources or may be monochromatic or laser sources. Similarly, the optical sensor 11 may be a grayscale sensor or may be arranged for color imaging, i.e. be a Bayer camera, have a three chip configuration or another suitable color imaging arrangement. The illumination sources BI and DI may be arranged in any useful manner with respect to the inspection sensor 10 and may include additional optical elements to direct and condition the light directed onto the wafer W, including, but not limited to, mirrors, filters, diffusers and the like (not shown). Note that illumination sources have been omitted in a number of the Figures for purposes of clarity.

As can be seen in FIG. 4, the inspection sensor 10 is mounted in a radially aligned orientation. As seen in FIGS. 5 and 6, the inspection sensors 10 may be arranged obliquely with respect to the wafer's edge or in some combination of oblique and radial alignment, respectively.

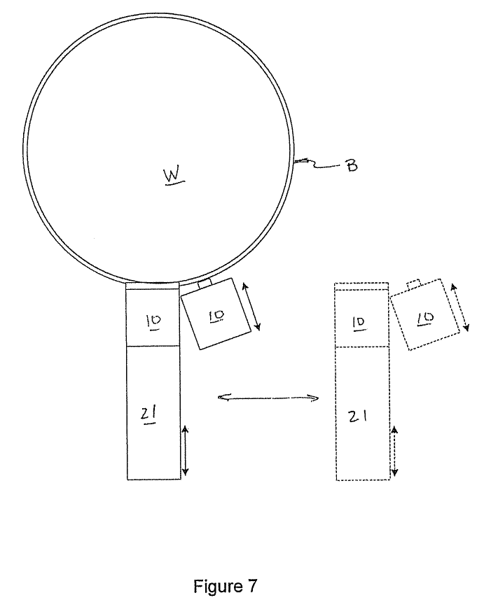

FIG. 7 schematically illustrates an embodiment in which the moveable mount 21 is adapted to move a number of inspection sensors 10 between an inspection position (leftmost position) and a rest position (rightmost position). This function permits the inspection sensors 10 to be employed in applications where there is limited space or where automation requirements demand that the inspection sensors 10 be moved out of the way during transfer of the wafers. This may be particularly useful in applications where the inspection sensors 10 are packaged for installation directly within a wafer handler, perhaps in lieu of or as an addenda to a wafer pre-alignment mechanism. Further, this embodiment may be useful where the wafers to be inspected are subject to random shape variations when the wafers W are addressed to the wafer support 24. For example, ground or very thin wafers have a distinct tendency towards warpage or bowing. In most instances this warpage is damped down by a wafer support 24 that incorporates vacuum channels therein. However, during the process of addressing a wafer to the wafer support 24, it is possible that a warped wafer W edge may touch or strike an inspection sensor 10. The moveable support 21 may move the inspection sensors 10 along a linear path (as illustrated) or along a curvilinear or complex path in the vertical or horizontal directions, as the case may be.

In use, one or more inspection sensors 10 are focused on selected region(s) of the wafer bevel B. The wafer is then rotated past the inspection sensor(s) 10 and sequential images (in the case of area scan optical sensors 11) or continuous images (in the case of line scan optical sensors 11) are obtained. The inspection sensor(s) 10 are focused and/or moved in a fashion that ensures that the selected region of the wafer bevel being inspected remains substantially within the depth of field of the optical system 14 of the optical sensor 10 during the inspection. Where the selected number of inspection sensors 10 are not sufficient to capture information or images of substantially the entire wafer edge, one or more of the inspection sensors 10 may be moved during the inspection in either a continuous or piecewise fashion so as to all the one or more inspection sensors 10 to capture information or images of a set of the selected regions. In one embodiment, once inspection at a selected optical system magnification level has been carried out and a set of defects of interest have been identified, a suitable second magnification level for the optical system is chosen (typically a higher magnification level) and images of the defects of interest are captured. Data concerning the defects of interest, at any selected magnification level are output to a control device, e.g. a computer, for processing such as spatial pattern recognition, automatic defect classification and/or for use in controlling and/or characterizing wafer manufacturing processes.

Although specific embodiments of the present disclosure have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations. It is manifestly intended that this disclosure be limited only by the following claims and equivalents thereof.

What is claimed is:

1. An edge inspection imaging system comprising:
a moveable mount coupled to a chassis of the edge inspection system adjacent to a wafer edge and moveable in relation thereto; and
at least one imaging sensor, the imaging sensor comprising an optical system including an optical sensor for capturing an optical image, the imaging sensor being coupled to the moveable mount so as to be moveable in relation to the wafer edge, the imaging sensor being positioned with respect to the wafer edge so maintain a selected edge region of the wafer edge within a depth of field of the optical system such that an image of the selected edge region captured by the optical sensor is substantially in focus.

2. The edge inspection imaging system of claim 1, wherein the moveable mount is positioned with respect to the wafer edge such that an optical axis of the imaging sensor is substantially normal to the selected edge region of the wafer edge and the selected edge region is substantially entirely within the depth of field of the imaging sensor.

3. The edge inspection imaging system of claim 1, further comprising a plurality of imaging sensors arranged to capture images of substantially all of the edge of the wafer.

4. The edge inspection imaging system of claim 3, comprising an imaging sensor positioned to capture images of an edge top region of the wafer edge, imaging sensor positioned to capture images of a top edge bevel region of the wafer edge, an imaging sensor positioned to capture images of an edge normal region of the wafer edge, an imaging sensor positioned to capture images of a bottom edge bevel region of the wafer edge, and an imaging sensor positioned to capture images of an edge bottom region of the wafer edge.

5. The edge inspection imaging system of claim 3, comprising a pair of imaging sensors, one mounted generally above the wafer edge and the other mounted generally below the wafer edge, each of the pair of imaging sensors being coupled to a moveable mount adapted to rotate with respect to the edge of the wafer, the rotation of the moveable mount being such that the edge portions within a field of view of the imaging sensors are maintained substantially within the depth of field of the respective imaging sensors.

6. The edge inspection imaging system of claim 5, wherein the respective moveable mount rotates their respective imaging sensors along a complex path, the shape of the complex path being at least partially correlated to the geometry of the wafer edge.

7. The edge inspection imaging system of claim 5, wherein an upper imaging sensor of the pair of imaging sensors is addressed to an top edge region, a top bevel region and at least a portion of the edge normal region of the wafer edge.

8. The edge inspection imaging system of claim 5, wherein a lower imaging sensor of the pair of imaging sensors is addressed to at least portions of a bottom edge region, a bottom bevel region and an edge normal region of the wafer edge.

9. The edge inspection imaging system of claim 1, wherein the imaging sensor is coupled to a moveable mount adapted to rotate with respect to the edge of the wafer, the rotation of the moveable mount being such that the edge portions within a field of view of the imaging sensors are maintained substantially within the depth of field of the respective imaging sensors.

10. The edge inspection imaging system of claim 9, wherein the imaging sensor is addressed to at least portions of a bottom edge region, a bottom bevel region, an edge normal region, a top bevel region, and a top edge region of the wafer edge.

11. The edge inspection imaging system of claim 1, wherein the optical sensor of the imaging system is selected from a group consisting of a line scan optical sensor and an area scan optical sensor.

12. The edge inspection imaging system of claim 1, wherein the optical system comprises a plurality of objectives of differing magnification levels.

13. The edge inspection imaging system of claim 1, wherein the moveable mount comprises a rotational stage having an axis of rotation that is non-parallel with respect to the imaging sensor optical axis, rotation of the imaging sensor by the rotational stage acting to tilt the depth of field of the imaging sensor with respect to the wafer edge.

14. The edge inspection imaging system of claim 13, wherein the axis of rotation of the rotational stage is offset from an axis of rotation of the wafer by about 1° to 45°.

15. The edge inspection imaging system of claim 1, wherein the moveable mount comprises a first linear stage positioned to permit the imaging sensor to be moved toward and away from an edge of the wafer generally along an optical axis of the imaging sensor.

16. The edge inspection imaging system of claim 15, wherein the moveable mount comprises a second linear stage positioned to permit the imaging sensor to be moved generally toward and away from an edge of the wafer independent of the first linear stage.

17. The edge inspection imaging system of claim 1, wherein the moveable mount comprises a linear stage positioned to permit the imaging sensor to be moved generally toward and away from an edge of the wafer.

18. The edge inspection imaging system of claim 1, further comprising a positioning apparatus positioned adjacent the wafer edge to determine a position of the wafer edge, the position of the wafer edge being reported by the positioning apparatus to a controller for the edge inspection system.

19. The edge inspection imaging system of claim 18, wherein the moveable mount comprises a linear stage positioned to permit the imaging sensor to be moved generally toward and away from an edge of the wafer, the linear stage of the moveable mount being adapted for moving the imaging sensor so as to maintain the imaging sensor in a position such that a selected edge region of the wafer edge is maintained substantially within the depth of field of the imaging system.

20. A method of inspecting an edge of a wafer comprising:
providing an imaging sensor for capturing optical images that is coupled to a moveable mount;
controlling the moveable mount to move the imaging sensor so as to maintain a selected region of a wafer edge in a depth of field of the imaging sensor;
capturing images of substantially the entire selected region of the wafer edge; and,
inspecting the captured images to identify defects on the selected region of a wafer edge.

21. The method of inspecting an edge of a wafer of claim 20, wherein the selected region of the wafer edge is selected from a group consisting of an edge top region, a top bevel region, an edge normal region, a bottom bevel region and a edge bottom region.

22. The method of inspecting an edge of a wafer of claim 22, wherein the selected region of the wafer edge comprises at least portions of at least two of a group consisting of an edge top region, a top bevel region, an edge normal region, a bottom bevel region and a edge bottom region.

23. The method of inspecting an edge of a wafer of claim 20, wherein the selected region of the wafer edge comprises at least portions of all regions of a group consisting of an edge top region, a top bevel region, an edge normal region, a bottom bevel region and a edge bottom region.

24. The method of inspecting an edge of a wafer of claim 20, further comprising capturing images of at least two edge regions of a wafer simultaneously using at least two imaging sensors.

25. The method of inspecting an edge of a wafer of claim 20, further comprising moving the imaging sensor to capture images of a plurality of regions of the wafer edge.

26. The method of inspecting an edge of a wafer of claim 20, wherein the moveable mount has at least two degrees of freedom for moving the imaging sensor.

27. The method of inspecting an edge of a wafer of claim 20, comprising capturing a first set of images of the selected region of the wafer edge at a first magnification level and capturing a second set of images of the selected region of the wafer edge at a second magnification level.

28. The method of inspecting an edge of a wafer of claim 27, wherein the second set of images captured by the imaging sensor include defects present in the first set of images.

29. The method of inspecting an edge of a wafer of claim 28, wherein second magnification level is greater than the first magnification level.
